(19) United States
(12) Patent Application Publication
(10) Pub. No.: US 2026/0106253 A1
(43) Pub. Date: Apr. 16, 2026

(54) BATTERY PROCESSING METHOD AND BATTERY PROCESSING SYSTEM

(71) Applicant: MAZDA MOTOR CORPORATION, Hiroshima (JP)

(72) Inventors: Susumu MINEOI, Aki-gun (JP); Tenyu YAN, Aki-gun (JP); Kenjiro MOMOSAKI, Aki-gun (JP); Tomoki YAMAMOTO, Aki-gun (JP)

(73) Assignee: MAZDA MOTOR CORPORATION, Hiroshima (JP)

(21) Appl. No.: 19/332,199

(22) Filed: Sep. 18, 2025

(30) Foreign Application Priority Data
Oct. 11, 2024 (JP) 2024-179307

(51) Int. Cl. H01M 10/54; B09B 3/40; B09B 3/80; B09B 101/16; H01M 10/613

(52) U.S. Cl. CPC H01M 10/54; B09B 3/40; B09B 3/80; H01M 10/613; B09B 2101/16

(57) ABSTRACT

The battery processing method for processing the lithium-ion battery including a positive electrode material and a negative electrode material includes a first lithium deposition step of depositing lithium on the negative electrode material by performing pulse charging while cooling the lithium-ion battery.

### CROSS-REFERENCE TO RELATED APPLICATION

The present application claims priority to Japanese Patent Application 2024-179307, filed Oct. 11, 2024, the entire contents of which are incorporated herein by reference.

### FIELD

Embodiments relate to a battery processing method and a battery processing system.

### BACKGROUND

In recent years, lithium-ion batteries have been widely used as in-vehicle batteries of electric-powered vehicles such as electric vehicles and hybrid vehicles. The lithium-ion battery contains valuable substances including lithium. It is requested to recycle valuable substances from the used lithium-ion batteries for resource circulation.

Patent Literature 1 discloses a method for increasing an amount of lithium contained in a positive electrode material by discharging the used lithium-ion battery to collect lithium from the positive electrode material.

### CITATION LIST

### Patent Literature

[Patent Literature 1] JP-A-2022-049831

### SUMMARY

The positive electrode material is generally configured by forming a positive electrode active material on a current collector foil such as aluminum. For example, in a case of a ternary system (NMC), the positive electrode active materials include the valuable substances such as nickel, manganese, and cobalt. In order to collect the valuable substances from the positive electrode active material, the positive electrode material is roasted together with a reducing agent and pulverized, and then a black mass or the like containing the positive electrode active material is selected. Next, the black mass is subjected to stepwise solvent extraction to sequentially extract manganese, cobalt, and nickel, and finally lithium is extracted. Thus, it takes time and effort to collect lithium in particular.

One or more embodiments may provide a battery processing method and a battery processing system capable of efficiently collecting lithium from a lithium-ion battery.

One or more embodiments may provide
a battery processing method for processing a lithium-ion battery including a positive electrode material and a negative electrode material, the battery processing method including:
a first lithium deposition step of depositing lithium on the negative electrode material by performing pulse charging while cooling the lithium-ion battery.

### Advantageous Effects

According to an embodiment, lithium can be efficiently collected from a negative electrode of the lithium-ion battery.

### BRIEF DESCRIPTION OF DRAWINGS

FIG. 1 is a block diagram schematically illustrating a reuse system according to a first embodiment.

FIG. 2 is a perspective view illustrating a schematic configuration of a lithium-ion battery.

FIG. 3 is a cross-sectional view illustrating a schematic configuration of a battery cell.

FIG. 4 is a flowchart schematically illustrating a flow of reuse of the lithium-ion battery.

FIG. 5 is a schematic view schematically illustrating an example of a cooling device according to the first embodiment.

FIG. 6 is a graph illustrating a relationship between a charging rate with respect to SOC and ease of deposition of lithium at each cooling temperature.

### DETAILED DESCRIPTION

The present inventors have conducted intensive studies to efficiently collect lithium from a lithium-ion battery, and have found that lithium can be efficiently collected from the lithium-ion battery by intentionally generating lithium deposition (for example, dendrite), which is not desirable in a normal charging reaction, on a negative electrode material. Based on this finding, the present inventors have completed a battery processing method capable of efficiently collecting lithium from the lithium-ion battery.

A method for reusing a lithium-ion battery according to an embodiment includes
a battery processing method for processing a lithium-ion battery including a positive electrode material and a negative electrode material, the battery processing method including:
a first lithium deposition step of depositing lithium on the negative electrode material by performing pulse charging while cooling the lithium-ion battery.

### First Embodiment

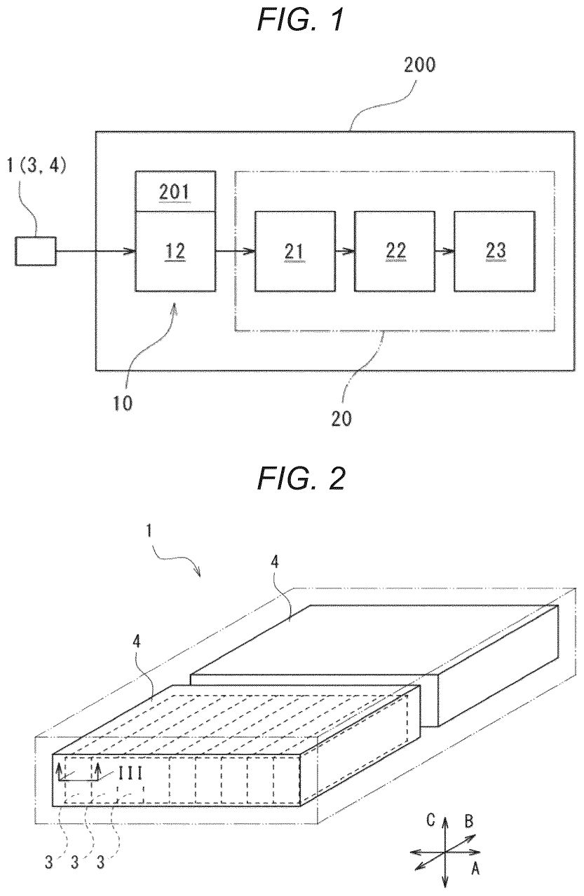

Hereinafter, a reuse system of a lithium-ion battery according to a first embodiment will be described with reference to the accompanying drawings. FIG. 1 is a block diagram schematically illustrating a reuse system 200 of a lithium-ion battery 1. As illustrated in FIG. 1, the reuse system 200 includes: a reuse unit 10 secondarily using the lithium-ion battery 1 that has been used primarily in an electric-powered vehicle, for example; and a recycle unit 20 collecting lithium from the lithium-ion battery 1 that has been used secondarily.

The reuse unit 10 reuses the lithium-ion battery 1, which has been used primarily, as an electrical storage device. In general, a deteriorated state of the lithium-ion battery for the electric-powered vehicle is determined on the basis of state of health (SOH) that indicates, for example, how much capacity is available in comparison with a new battery when the battery is fully charged. When it is determined that the lithium-ion battery 1 is inappropriate for use in the electric-powered vehicle on the basis of a degree of the deterioration, it is removed from the vehicle, and is used, in the reuse unit 10, as the electrical storage device for any of various secondary applications, such as a storage of renewable energy including solar power and wind power and a backup power source in the event of a disaster. For example, when the SOH becomes 70% or less, it may be determined that it is inappropriate for the primary use, that is, for use in the electric-powered vehicle.

The reuse unit 10 includes the lithium-ion battery 1, which is used secondarily as the electrical storage device, a charging device 12, and a cooling device 201. The charging device 12 is configured to enable intermittent charging (also referred to as pulse charging) at a predetermined voltage and a predetermined current by adjusting a voltage and a current. An upper limit of the charging voltage by the charging device 12 is a withstand voltage of the lithium-ion battery 1 or less, and is 4.3 V or less, for example.

The cooling device 201 may be a suitable cooling device of any appropriate type. In the present embodiment, a thermostatic bath is adopted as the cooling device 201.

The recycle unit 20 includes: a disassembly device 21 that disassembles the lithium-ion battery 1 into a positive electrode material 31, a negative electrode material 35, and the like through a lithium deposition step described below when it is determined that the lithium-ion battery 1 can be inappropriate for the secondary use on the basis of the SOH, for example; an extraction device 22 that extracts lithium from the negative electrode material 35 after the disassembly; and a collection device 23 that collects extracted lithium. For example, when the SOH becomes 40% or less, it may be determined that it can be inappropriate for the secondary use.

FIG. 2 schematically illustrates the lithium-ion battery 1 that is mounted on an electric-powered vehicle. The lithium-ion battery 1 constitutes a battery pack having battery modules 4, each of which incorporates functions as a charge/discharge circuit, a cooling mechanism, and the like. Furthermore, the plural battery modules 4 are connected to each other and accommodated in a case. Each of the battery modules 4 is formed by connecting plural battery cells 3 in series or in parallel with each other, and is adjusted to desired capacity and a desired voltage.

The lithium-ion battery 1 is a rechargeable lithium-ion secondary battery. In the present specification, the term “lithium-ion battery” may collectively refer to the battery cell, the battery module, and the battery pack unless otherwise specified.

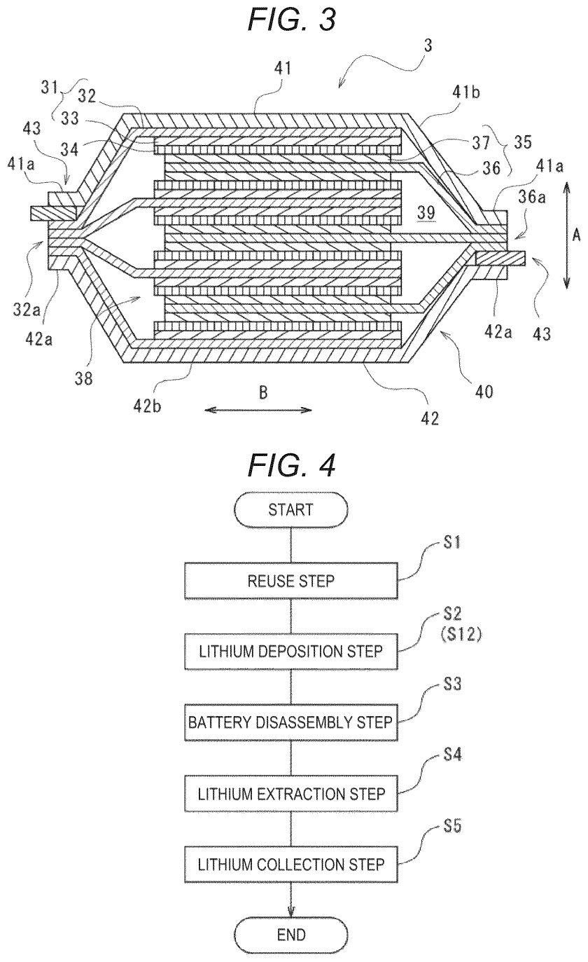

FIG. 3 is a cross-sectional view schematically illustrating the battery cell 3. As illustrated in FIG. 3, the battery cell 3 according to the present embodiment is of a laminated type. The battery cell 3 includes: a laminated electrode body 38 in which the positive electrode material 31, a separator 34, and the negative electrode material 35 are laminated in this order in a lamination direction A; and a case 40 that accommodates the laminated electrode body 38.

In the present embodiment, the laminated electrode body 38 is formed by laminating plural sets of the positive electrode material 31, the separator 34, and the negative electrode material 35 in the lamination direction A. The laminated electrode body 38 includes a positive electrode current collector end portion 32a, in which plural positive electrode current collectors 32 are connected, in one end portion (a left side in FIG. 3) in a width direction B (a left-right direction in FIG. 3) orthogonal to the lamination direction A, and includes a negative electrode current collector end portion 36a, in which plural negative electrode current collectors 36 are connected, in the other end portion (a right side in FIG. 3). The battery cell 3 has a rectangular shape that is elongated in the width direction B when viewed in the lamination direction A.

The positive electrode material 31 includes a positive electrode current collector 32 and a positive electrode active material 33 that is laminated on a surface of the positive electrode current collector 32 facing the separator 34. In a positive electrode current collector end portion 32a, the plural positive electrode current collectors 32 are connected to each other at one end (the left side in FIG. 3) in the width direction B that is orthogonal to the lamination direction. A metal foil suitable for a positive electrode can be suitably used for each of the positive electrode current collectors 32. A material that is used as a positive electrode active material of the lithium-ion secondary battery can be used as the positive electrode active material 33. In the present embodiment, each of the positive electrode current collectors 32 is made of aluminum, and the positive electrode active material 33 is made of NMC (nickel, manganese, and cobalt).

The negative electrode material 35 includes a negative electrode current collector 36 and a negative electrode active material 37 that is laminated on a surface of the negative electrode current collector 36 facing the separator 34. In a negative electrode current collector end portion 36a, the plural negative electrode current collectors 36 are connected to each other at the other end (a right side in FIG. 3) in the width direction B. A metal foil suitable for a negative electrode can be suitably used for each of the negative electrode current collectors 36. A material that is used as a negative electrode active material of the lithium-ion secondary battery can be used for the negative electrode active material 37. In the present embodiment, each of the negative electrode current collectors 36 is made of copper, and the negative electrode active material 37 is a carbon material (graphite) that has a layer structure.

The positive electrode active material 33 and the negative electrode active material 37 each contain an electrolytic solution 39. The electrolytic solution 39 is, for example, an organic solvent in which lithium ions can move. In the present embodiment, the electrolytic solution 39 contains dimethyl carbonate (DMC), ethylene carbonate (EC), and diethyl carbonate (DEC) in a volume ratio of 1:1:1, and contains lithium hexafluoride phosphate (LiPF₆) at a concentration of 1 mol/L.

The separator 34 is disposed between the positive electrode material 31 and the negative electrode material 35, and physically and electrically separates them from each other. The separator 34 may be a porous body having plural minute pores through which the lithium ions can pass. In the present embodiment, the separator 34 is a porous film that is made of polyolefin.

The case 40 includes a first case 41 and a second case 42 that are provided as a pair on both sides in the lamination direction A of the laminated electrode body 38. The first case 41 and the second case 42 are each formed to have a hat-shaped cross section. The first case 41 includes: a pair of flange portions 41a located at both ends in the width direction B; and a body portion 41b that is located between the paired flange portions 41a and bulges in a direction away from the second case 42 in the lamination direction A. Similarly, the second case 42 includes a pair of flange portions 42a and a body portion 42b that bulges in a direction away from the first case 41.

The first case 41 and the second case 42 are joined to each other in a state of sandwiching the positive electrode current collector end portion 32a and the negative electrode current collector end portion 36a between the flange portions 41a, 42a, and thereby constitute the case 40. That is, in a state where the laminated electrode body 38 is accommodated in the case 40, the positive electrode current collector end portion 32a and the negative electrode current collector end portion 36a are sandwiched between the paired flange portions 41a, 42a, and a remaining portion of the laminated electrode body 38 is accommodated in a space that is defined between the paired body portions 41b, 42b. In the state of being accommodated in the case 40, the laminated electrode body 38 is crimped with a predetermined pressure in the lamination direction A by the paired body portions 41b, 42b. An example of a tab 43 according to an embodiment is formed by a portion, which is sandwiched by the paired flange portions 41a, 42a, in the battery cell 3.

Next, reuse of the lithium-ion battery 1 will be described. FIG. 4 is a flowchart schematically illustrating a flow of reuse of the lithium-ion battery 1. As illustrated in FIG. 4, when it is determined that the lithium-ion battery 1, which is mounted on an electric-powered vehicle, is in the deteriorated state that is not suitable for use in the electric-powered vehicle on the basis of the SOH, for example, a reuse step (step S1) is executed to remove it from the electric-powered vehicle and subject it to secondary use in the reuse unit 10.

In a case where it is determined that the lithium-ion battery 1 is in a predetermined deteriorated state after being used secondarily as the electrical storage device 11, a lithium deposition step (step S2) is executed to deposit lithium on the negative electrode material 35 following the secondary use in the reuse unit 10. In the lithium deposition step S2, lithium is deposited on the negative electrode material 35. In the lithium deposition step S2, the pulse charging is performed while the lithium-ion battery 1 is cooled to deposit lithium on the negative electrode material 35.

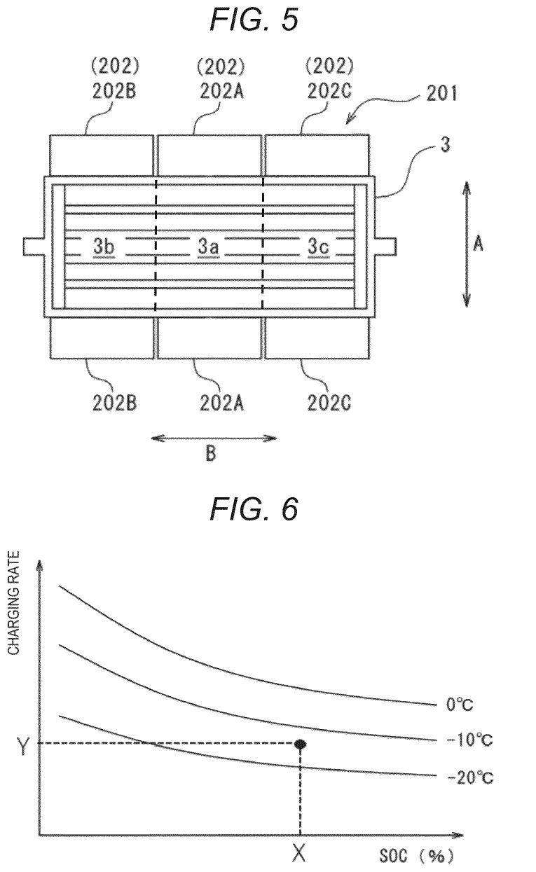

FIG. 5 is a view schematically illustrating the cooling device 201. FIG. 5 also schematically illustrates the battery cell 3 that is cooled by the cooling device. As illustrated in FIG. 5, a pair of the cooling devices 201 is provided on both sides of the battery cell 3 in the lamination direction A. In addition, it may be configured that a single cooler covers the entire battery cell 3 in the width direction B on one side of the paired cooling devices 201, or, as illustrated in FIG. 5, it may be configured to provide plural sets of cooler pairs 202 that are formed by dividing them in the width direction B of the battery cell 3. In the present embodiment, a central cooler pair 202A for cooling the central portion 3a of the battery cell 3 and cooler pairs 202B, 202C for respectively cooling both side portions 3b, 3c of the battery cell 3 are provided. When being divided, the number of cooler pairs 202 may be three, or may be two, four, or more. For example, when the battery cell 3 is cooled only by the central cooler pair 202A, lithium is preferentially or selectively deposited on the negative electrode material 35 that is located in a central portion from an end portion in the width direction B. In an implementation, the cooler may be in the form of the pair, or may be disposed only on one side (an upper side or a lower side in FIG. 5) in the lamination direction A, for example.

In the lithium deposition step S2, the lithium-ion battery 1 is charged while being cooled by the cooling device 201 under a predetermined cooling condition. Here, a graph in FIG. 6 illustrates a relationship between a charging rate and ease of deposition of lithium with respect to state of charge (SOC) at each temperature. More specifically, when charging is performed in a region above a curve at each temperature, the deposition of lithium is facilitated on the negative electrode material 35. The SOC is an index indicating a charged state of the battery, and indicates battery capacity at the time when a fully charged state is set as 100% and a completely discharged state is set as 0%. As illustrated in FIG. 6, lithium is more likely to be generated as the SOC of the lithium-ion battery 1 is increased and/or as the temperature thereof is reduced.

In the lithium deposition step S2, cooling may be performed to a temperature at which lithium starts being deposited. Here, the “temperature at which lithium starts being deposited” is a temperature that is determined by the SOC and the charging rate of the lithium-ion battery 1. For example, in FIG. 6, a relationship between the SOC and the charging rate when the “temperature at which lithium starts being deposited” is each of 0° C., −10°C., or −20° C. is indicated by a curve (hereinafter, referred to as a “temperature curve”). For example, when a measured value of the SOC of the lithium-ion battery 1 to be reused is set as X, and the charging rate in the lithium deposition step that is arbitrarily selected is set as Y, as illustrated in FIG. 6, an intersection point of X and Y lies between the temperature curves of −10° C. and −20° C. In this case, −20° C. to −10° C. is the “temperature at which lithium starts being deposited”. A method for measuring the SOC of the lithium-ion battery 1 may be a suitable method. For example, it may be calculated by deriving an SOC-open circuit voltage (OCV) curve on the basis of a known battery model in the lithium-ion battery 1 as a subject and further measuring and applying the OCV of the battery to the SOC-OCV curve.

The cooling temperature varies by a use environment, a type, and the like of the lithium-ion battery 1. However, when the lithium-ion battery 1 is of a so-called capacitive type (also referred to as an energy type) that is mounted on an electric vehicle, for example, it can be 20° C. or less, 10° C. or less, 0° C. or less, −5° C. or less, −10° C. or less, −20° C. or less, or −30° C. or less, and can be −50° C. or more, −40° C. or more, −30° C. or more, −25° C. or more, or −20° C. or more. From a viewpoint of reliably depositing lithium on the cooled portion, the temperature may be 10° C. or less. In addition, in order to prevent the deposition of lithium on the entire lithium-ion battery 1 due to excessive cooling, the cooling temperature may be −40° C. or more. In one aspect, the cooling temperature can be from −40° C. to 10° C.

Although not being bound by a theory, seed crystals of lithium can be deposited from a relatively early stage in the lithium deposition step S2 by setting the cooling temperature in the above range, which can lead to the deposition of a larger amount of lithium after completion of the lithium deposition step S2.

In the present specification, the lithium-ion battery 1 being of the capacitive type means a case where the energy density thereof is 600 Wh/L or more. In addition, the lithium-ion battery 1 being of the high-output type means a case where the output density (kW/kg or kW/L) is 4000 kW/L or more.

A cooling rate during cooling may be 0.1° C./min to 50° C./min, for example. From a viewpoint of unevenly distributing deposition positions of lithium, the cooling rate may be 1° C./min to 50° C./min. In the present disclosure, the “cooling rate” is a parameter that is based not on a temperature of a surrounding environment but on a temperature inside the battery.

In the lithium deposition step S2, the lithium-ion battery 1 is subjected to the pulse charging while being cooled to deposit lithium on the negative electrode material 35. Since the lithium-ion battery 1 is cooled in the lithium deposition step S2, the seed crystals of lithium can be deposited on the negative electrode material 35 from the relatively early stage during the pulse charging in the step. When the pulse charging further proceeds, lithium is sequentially deposited on these seed crystals, and lithium crystals grow. Thus, the deposition of the seed crystals of lithium on the negative electrode material 35 from the early stage can lead to the deposition of the larger amount of lithium after the completion of the lithium deposition step S2.

Furthermore, in the lithium deposition step S2, the lithium-ion battery 1 is subjected to the pulse charging. In a case of normal charging (also referred to as continuous charging) that is not the pulse charging, the normal charging reaction can also occur along with the deposition of lithium. Meanwhile, when the lithium-ion battery 1 is subjected to the pulse charging having instantaneously higher output than that of the continuous charging, a large amount of energy is consumed in a lithium deposition reaction that requires the high energy. Thus, it is possible to efficiently deposit the larger amount of lithium than that in the normal charging reaction.

Pulse charging conditions vary by the use environment, the type, and the like of the lithium-ion battery 1. For example, when the lithium-ion battery 1 is of the so-called capacitive type that is mounted on the electric vehicle, a pulse charging frequency can be 0.1 to 100 Hz, e.g., 0.1 to 10 Hz, or 0.1 to 1 Hz. In addition, the voltage of the pulse charging can be from 3.8 to 4.3 V.

The pulse charging may be performed by high-rate pulse charging. In the present specification, the high-rate pulse charging means charging with such a large current that intentionally generates lithium on the negative electrode material 35 during the pulse charging.

For example, when being of the capacitive type, the lithium-ion battery 1 may be subjected to the pulse charging with the current of 2 C or more, for example. Meanwhile, when the lithium-ion battery 1 is of a so-called high-output type (also referred to as a power type) that is mounted on a hybrid vehicle, it may be subjected to the pulse charging with the current of 10 C or more, for example. Here, the current of 1 C means the current that is required to fully charge each of the lithium-ion batteries in one hour. Lithium can be deposited further efficiently on the negative electrode material 35 by the intermittent high-rate pulse charging for a predetermined time.

When the charging current in the high-rate pulse charging becomes excessively large, the unfavorable side reactions, such as the gasification of the electrolytic solution 39 and the deformation and the damage of each of the components, possibly occur due to the heat generation. Thus, from the viewpoint of the energy saving, excessive charging current is not preferable. For example, when the lithium-ion battery 1 is of the capacitive type, the upper limit of the charging current may be set to about 3 C. Meanwhile, when the lithium-ion battery 1 is of the high-output type, the upper limit of the charging current may be set to about 20 C.

Here, in the lithium deposition step S2, the lithium-ion battery 1 only needs to be charged in the cooled state. Cooling of the lithium-ion battery 1 by the cooling device 201 and charging of the lithium-ion battery 1 by the charging device 12 may be started simultaneously, or one thereof may be started first. That is, after cooling by the cooling device 201 is performed, the charging device 12 may perform charging while the cooling state by the cooling device 201 is maintained. From a viewpoint of depositing the seed crystals of lithium as early as possible, cooling may be started first.

Next, the lithium-ion battery 1 is removed from the reuse unit 10, and a battery disassembly step (step S3) is executed by the disassembly device 21. In the battery disassembly step, the lithium-ion battery 1 is disassembled into components such as the positive electrode material 31, the separator 34, the negative electrode material 35, and the case 40. When only the collection of lithium is intended, at least the negative electrode material 35 may only be disassembled. The disassembly device 21 may be any appropriate device that automatically disassembles the lithium-ion battery 1. Here, the lithium-ion battery 1 may be disassembled manually by using a tool or the like without using the disassembly device 21.

Next, a lithium extraction step (step S4) is executed. In the lithium extraction step S4, lithium is extracted from the disassembled negative electrode material 35. In the lithium extraction step S4, after the negative electrode material 35 is exuded with water, which is then filtered, the extraction device 22 removes the negative electrode current collector 36 and the negative electrode active material 37 from the negative electrode material 35, and thereby extracts an aqueous solution containing lithium ions.

In addition, in the disassembled negative electrode material 35, a portion having a larger lithium deposition amount than the other portions in the lithium deposition step S2 or a second lithium deposition step S22 described below may be subjected to the lithium extraction step S4. In this way, lithium may be efficiently extracted.

Finally, a lithium collection step (step S5) is executed. In the lithium collection step S5, lithium is collected from the aqueous solution containing the lithium ions. In the lithium collection step S5, after subjecting lithium to a solution treatment with carbonated water, the collection device 23 filters the solution and collects lithium as lithium carbonate.

Since the negative electrode material 35 is generally formed by laminating graphite on the current collector foil, such as copper, in the form of the layer, it contains less types of valuable substances than the positive electrode material 31 that has plural types of the valuable substances such as cobalt, nickel, and manganese. Accordingly, unlike a case where lithium is collected from the positive electrode material 31, it does not require time and effort for stepwise solvent extraction of plural types of the valuable metals. Thus, lithium can be efficiently collected from the negative electrode material 35.

In the first embodiment described above, the description has been made on the case where, after the lithium-ion battery 1 is subjected to the reuse step S1 in the form of the battery pack, the lithium deposition step S2 is executed. In the reuse step S1 and/or the lithium deposition step S2, the lithium-ion battery 1 may be subjected in the form of the battery module 4 or the battery cell 3.

### Second Embodiment

In a second embodiment, a lithium deposition step S12 is executed instead of the lithium deposition step S2 according to the first embodiment. The lithium deposition step S12 differs in that the second lithium deposition step S22 is adopted in addition to the lithium deposition step S2 according to the first embodiment. The second lithium deposition step S22 is a step of repeating discharging of the lithium-ion battery 1, the subsequent pulse charging, and the deposition of lithium on the negative electrode material 35 at least once.

In the discharging in the second lithium deposition step S22, a discharge rate may be a suitable discharge rate, and the discharging may be performed at the same rate as charging performed in the lithium deposition step S2, for example. In addition, the discharging may be pulse discharging or continuous discharging, but may be performed by the continuous discharging.

With reference to FIG. 1, the discharging in the second lithium deposition step S22 may be in a mode in which the reuse system 200 newly includes a discharging device or in a mode in which a device that can also discharge electric power may be adopted as the charging device 12. The discharging device can continuously discharge the electric power at the predetermined voltage and the predetermined current by adjusting the voltage and the current. Alternatively, it may be configured to be able to intermittently discharge the electric power at the predetermined voltage and the predetermined current. An upper limit of the discharge voltage by the discharging device is the withstand voltage of the lithium-ion battery 1 or less, and is 4.3 V or less, for example.

A cooling condition in the second lithium deposition step S22 may be any of the conditions listed in the description of the lithium deposition step S2. Alternatively, the cooling condition in the second lithium deposition step S22 may be a different condition from that in the lithium deposition step S2 depending on the battery deteriorated state, a lithium ion absorption state of the negative electrode active material 37, and the like. For example, in the second lithium deposition step S22, from a viewpoint of depositing a larger amount of the seed crystals of lithium than that in the lithium deposition step S2, the cooling temperature may be 1° C., 2° C., 3° C., 5° C., or 5° C. less than that in the lithium deposition step S2.

A pulse charging condition in the second lithium deposition step S22 may be any of the conditions listed in the description of the lithium deposition step S2. Alternatively, the cooling condition in the second lithium deposition step S22 may be a different condition from that in the lithium deposition step S2 depending on the battery deteriorated state and the like. For example, in the second lithium deposition step S22, from a viewpoint of depositing the larger amount of lithium than that in the lithium deposition step S2, the pulse charging may be performed at a higher rate than the rate in the lithium deposition step S2.

In the second lithium deposition step S22, the discharging and the pulse charging are each performed at least once. From a viewpoint of depositing the larger amount of lithium on the negative electrode material 35 upon completion of the second lithium deposition step S22, the number of repetitions of a set of the discharging and the pulse charging may be twice or more, three times or more, five times more, seven times or more, eight times or more, or ten times or more, and may be three times or more. In addition, as the number of the repetitions of the discharging and the pulse charging is increased, the amount of lithium that can be deposited on the negative electrode material 35 converges to a constant value. Thus, the excessive number of the repetitions leads to energy loss. Accordingly, the number of the repetitions may be 30 times or less, 25 times or less, 20 times or less, 15 times or less, 10 times or less, or 8 times or less, and may be 10 times or less.

Due to the temperature increase during the second lithium deposition step S22, lithium that has been ionized again is absorbed in a region (an active region), where lithium ion absorption capacity still remains, in the negative electrode active material 37. By repeating the deposition of lithium in subsequent cooling and charging and the absorption of lithium ions in the active region of the negative electrode active material 37 by the further temperature increase, an absorption amount of lithium ions in the entire negative electrode active material 37 converges to a constant upper limit value. Accordingly, by repeating the temperature increase, cooling, and charging in the second lithium deposition step S22 for the suitable number of times, the larger amount of lithium can be deposited on the negative electrode material 35 than that in a case of executing up to the second lithium deposition step S22.

In the second embodiment, the description has been made on, as the example, the case where the second lithium deposition step S12 is executed after the lithium-ion battery 1 is provided in the form of the battery cell 3 in the reuse step S1. In the reuse step S1 and/or the second lithium deposition step S12, the lithium-ion battery 1 may be provided in the form of the battery pack or the battery module 4. In this case, the cooling device 201 may be built in the battery pack or the battery module 4 in advance.

The reuse system 200 of the lithium-ion battery 1 according to the present disclosure may correspond to the configuration described in the above embodiment, or various modifications can be made thereto.

In the above embodiment, the description has been made on the example in which the lithium-ion battery is of the laminated type. For example, a lithium-ion battery in a cylindrical shape or a polygonal shape may be adopted, which is formed by winding a belt-shaped laminated electrode body, in which a belt-shaped positive electrode material, a belt-shaped separator, and a belt-shaped negative electrode material are laminated in the lamination direction A, in a cylindrical shape or a square shape. In a case of the cylindrical shape or the polygonal shape, the lamination direction corresponds to a radial direction orthogonal to a winding direction.

Although the description has been made on a cell-by-cell basis, it may be implemented on a module-by-module basis or on a battery pack-by-battery pack basis. In a case of the implementation on the battery pack-by-battery pack basis, the pressing device, the cooling device, and the like may be provided in the battery pack in advance.

### Additional Remarks

According to the reuse system 200 of the lithium-ion battery 1 according to an embodiment, the following aspects are provided.

### First Aspect

The battery processing method for processing the lithium-ion battery including the positive electrode material and the negative electrode material, the battery processing method including:
the first lithium deposition step of depositing lithium on the negative electrode material by performing the pulse charging while cooling the lithium-ion battery.

### Second Aspect

The battery processing method according to the first aspect, in which, in the first lithium deposition step, cooling is performed to a temperature at which lithium starts being deposited.

### Third Aspect

The battery processing method according to the first or second aspect, in which, in the first lithium deposition step, the lithium-ion battery is cooled to a range of −40° C. to 10° C.

### Fourth Aspect

The battery processing method according to any one of the first to third aspects, in which, in the first lithium deposition step, the pulse charging is performed by the high-rate pulse charging.

### Fifth Aspect

The battery processing method according to any one of the first to fourth aspects, in which, in the first lithium deposition step, the pulse charging is performed at a pulse charging frequency of 0.1 Hz to 100 Hz.

### Sixth Aspect

The battery processing method according to any one of the first to fifth aspects further including:
the second lithium deposition step of, after the first lithium deposition step, discharging of the lithium-ion battery, and then repeating the subsequent pulse charging and the depositing lithium on the negative electrode material at least once.

### Seventh Aspect

The battery processing method according to any one of the first to sixth aspects further including:
the battery disassembly step of disassembling at least the negative electrode material from the lithium-ion battery; and
the lithium extraction step of extracting the lithium from the negative electrode material.

### Eighth Aspect

The battery processing system for processing the lithium-ion battery including the positive electrode material and the negative electrode material, the battery processing system including:
the cooling device capable of cooling the lithium-ion battery; and
the discharging device capable of performing the pulse charging of the lithium-ion battery.

### Ninth Aspect

The battery processing system according to the eighth aspect further including:
a discharging device capable of discharging the lithium-ion battery.

### REFERENCE SIGNS LIST

1: lithium-ion battery
3: battery cell
4: battery module
10: reuse unit
12: charging device
20: recycle unit
21: disassembly device
22: extraction device
23: collection device
31: positive electrode material
34: separator
35: negative electrode material
38: laminated electrode body
39: electrolytic solution
40: case
200: reuse system
201: Cooling device

1. A battery processing method for processing a lithium-ion battery including a positive electrode material and a negative electrode material, the battery processing method comprising:
a first lithium deposition step of depositing lithium on the negative electrode material by performing pulse charging while cooling the lithium-ion battery.

2. The battery processing method according to claim 1, wherein, in the first lithium deposition step, the lithium-ion battery is cooled to a temperature at which the lithium starts being deposited.

3. The battery processing method according to claim 1, wherein, in the first lithium deposition step, the lithium-ion battery is cooled to a temperature of −40° C. to 10° C.

4. The battery processing method according to claim 1, wherein, in the first lithium deposition step, performing the pulse charging includes performing high-rate pulse charging.

5. The battery processing method according to claim 1, wherein, in the first lithium deposition step, the pulse charging is performed at a pulse charging frequency of 0.1 Hz to 100 Hz.

6. The battery processing method according to claim 1, further comprising:
at least one second lithium deposition step after the first lithium deposition step, the second lithium deposition step including discharging the lithium-ion battery, and then performing pulse charging on the lithium-ion battery and depositing lithium on the negative electrode material.

7. The battery processing method according to claim 1, further comprising:
a battery disassembly step of disassembling at least the negative electrode material from the lithium-ion battery; and
a lithium extraction step of extracting the lithium from the negative electrode material.

8. The battery processing method according to claim 1, wherein the pulse charging is performed with a charging device that is configured to intermittently charge at a predetermined voltage and a predetermined current by adjusting a voltage and a current.

9. The battery processing method according to claim 8, wherein the cooling is performed with at least one pair of cooling devices, the at least one pair of the cooling devices being provided on both sides of the lithium-ion battery in a lamination direction of the lithium-ion battery.

10. The battery processing method according to claim 9, wherein:
the at least one pair of cooling devices includes a plurality of cooler pairs,
the plurality of cooler pairs includes a central cooler pair configured to cool a central region of the lithium-ion battery and side cooler pairs configured to respectively cool both side regions of the lithium-ion battery.

11. A battery processing system for processing a lithium-ion battery including a positive electrode material and a negative electrode material, the battery processing system comprising:
a cooling device configured to cool the lithium-ion battery; and
a charging device configured to perform pulse charging of the lithium-ion battery.

12. The battery processing system according to claim 11, further comprising a discharging device configured to discharge the lithium-ion battery.

13. The battery processing system according to claim 11, wherein:
the cooling device includes a plurality of cooler pairs,
the plurality of cooler pairs includes a central cooler pair configured to cool a central region of the lithium-ion battery and side cooler pairs configured to respectively cool both side regions of the lithium-ion battery.

14. The battery processing system according to claim 11, wherein the cooling device is configured to cool the lithium-ion battery cooling to a temperature of −40° C. to 10° C.

15. The battery processing system according to claim 11, wherein the charging device is configured to perform pulse charging at a pulse charging frequency of 0.1 Hz to 100 Hz.

16. The battery processing system according to claim 11, wherein the charging device is configured to intermittently charge at a predetermined voltage and a predetermined current by adjusting a voltage and a current.
